(19) United States
(12) Patent Application Publication
(10) Pub. No.: US 2012/0028157 A1
(43) Pub. Date: Feb. 2, 2012

(54) SOLID OXIDE FUEL CELL STACK

(76) Inventor: Hyun-Min Son, Yongin-si (KR)

(21) Appl. No.: 13/171,362

(22) Filed: Jun. 28, 2011

(30) Foreign Application Priority Data
Jul. 27, 2010 (KR) 10-2010-0072364

(51) Int. Cl. H01M 8/04; H01M 8/24

(52) U.S. Cl. 429/443

(57) ABSTRACT

A solid oxide fuel cell stack is provided in which a separate fuel-blocking unit is provided to each fuel supply tube that connects a fuel supply unit to each bundle portion of the stack, so that the fuel supply to a defective bundle portion may be selectively blocked, thereby preventing the risk of explosion due to fuel leakage and the performance degradation of the other bundle portions. To this end, a fuel cell stack includes a bundle portion including unit cells each having a stacked structure of a first electrode, an electrolytic layer, and a second electrode, and a manifold having the unit cells connected thereto. A fuel supply portion is connected to the manifold of the bundle portion through a fuel supply tube provided at one side thereof. A fuel-blocking unit is connected to the fuel supply tube to block the fuel supply tube.

### CROSS-REFERENCE TO RELATED APPLICATIONS

This application claims priority to and the benefit of Korean Patent Application No. 10-2010-0072364, filed on Jul. 27, 2010, in the Korean Intellectual Property Office, the entire content of which is incorporated herein by reference.

### BACKGROUND

1. Field

Aspects of embodiments according to the present invention relate to a stack of fuel cells, and more particularly, to a solid oxide fuel cell stack.

2. Description of the Related Art

In a solid oxide fuel cell, a plurality of unit cells is connected to a manifold to form a bundle portion. Further, a plurality of bundle portions is connected to a separate fuel supply unit to form a stack.

However, the bundle portions are simultaneously connected to one fuel supply unit to receive fuel supplied from the fuel supply unit. In this instance, a fuel supply tube is separately provided to each of the bundle portions. Therefore, in a case where a specific one of the plurality of bundle portions has a defect, it is generally not possible to selectively block the fuel supply to the defective bundle portion without blocking the entire fuel supply to the other bundle portions as well.

Accordingly, the fuel is continuously supplied to the defective bundle portion and its unit cells. Therefore, the defective bundle portion may explode, and the performance of the other bundle portions may be degraded.

### SUMMARY

In one embodiment, there is provided a solid oxide fuel cell stack for selectively blocking only the fuel supply to a specific bundle portion in a case where the use of the specific bundle portion is impossible due to a defect.

According to an exemplary embodiment of the present invention, a fuel cell stack is provided. The fuel cell stack includes a bundle portion, a fuel supply portion, and a fuel-blocking unit. The bundle portion includes a plurality of unit cells and a manifold having the plurality of unit cells connected thereto. Each of the unit cells has a stacked structure of a first electrode, an electrolytic layer, and a second electrode. The fuel supply portion is connected to the manifold of the bundle portion through a fuel supply tube provided at one side thereof. The fuel-blocking unit is connected to the fuel supply tube. The fuel-blocking unit is configured to block the fuel supply tube.

The bundle portion may include a plurality of bundle portions. The bundle portions may be electrically connected to one another.

The fuel supply tube may include a plurality of fuel supply tubes. The fuel-blocking unit may include a plurality of fuel-blocking units. The fuel supply tubes may be connected to respective ones of the bundle portions. The fuel-blocking units may be connected to respective ones of the fuel supply tubes.

The fuel-blocking unit may include an accommodating portion that accommodates a fuel-blocking member. The fuel-blocking unit may include a connection tube to communicate with the interior of the fuel supply tube.

The fuel-blocking member may include slurry.

The fuel-blocking member may include a ceramic material having a plastic deforming temperature of about 800° C. or higher.

The fuel-blocking member may be plastically deformed near a driving temperature of the fuel cell stack.

The fuel-blocking member may have a porosity of less than 10% in its plastic deformation.

The fuel supply tube may be formed in a shape of a curved flow path so that the fuel-blocking member is configured to inject into the curved flow path.

The connection tube may be connected to a curved portion of the fuel supply tube.

The fuel-blocking unit may include a straight-line guide tube of which one end is connected to the fuel supply tube. The fuel-blocking member may be configured to move through the guide tube.

The fuel-blocking member may be formed in a shape of a block that is installed and configured to move in the guide tube.

The fuel-blocking unit may further include a driving portion connected to the fuel-blocking member to move the fuel-blocking member.

The fuel-blocking member may be configured to be circumscribed in the fuel supply tube.

The fuel cell stack may be a solid oxide fuel cell stack.

As described above, according to an embodiment of the present invention, only the fuel supply to a specific bundle portion with a defect is selectively blocked in a fuel cell stack, so that it is possible to prevent the risk of explosion due to fuel leakage that may occur in the defective bundle portion. In addition, the fuel supply to a specific bundle portion is selectively blocked, so that it is possible to prevent the degradation of the performance of the other bundle portions or unit cells, thereby stably driving the fuel cell stack.

### BRIEF DESCRIPTION OF THE DRAWINGS

The accompanying drawings, together with the specification, illustrate exemplary embodiments of the present invention, and, together with the description, serve to explain aspects and/or principles of the present invention.

FIG. 1 is a schematic view showing the structure of a related fuel cell stack.

FIG. 2 is a schematic view showing the fuel supply structure of a solid oxide fuel cell stack according to an embodiment of the present invention.

FIG. 3 is an enlarged schematic view showing the structure of each bundle portion in the stack of FIG. 2.

FIG. 4 is a schematic view of a fuel-blocking unit according to a first embodiment of the present invention.

FIG. 5 is a schematic view showing a fuel supply tube that is blocked by a fuel-blocking member in the fuel-blocking unit of FIG. 4.

FIG. 6 is a schematic view of a fuel-blocking unit according to a second embodiment of the present invention.

FIG. 7 is a schematic view of a fuel-blocking unit according to a third embodiment of the present invention.

### DETAILED DESCRIPTION

In the following detailed description, certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the other element or be indirectly on the other element with one or more intervening elements interposed therebetween. In addition, when an element is referred to as being “connected to” another element, it can be directly connected to the other element or be indirectly connected to the other element with one or more intervening elements interposed therebetween. Hereinafter, like reference numerals refer to like elements. In the drawings, the thickness or size of layers may be exaggerated for clarity and are not necessarily drawn to scale.

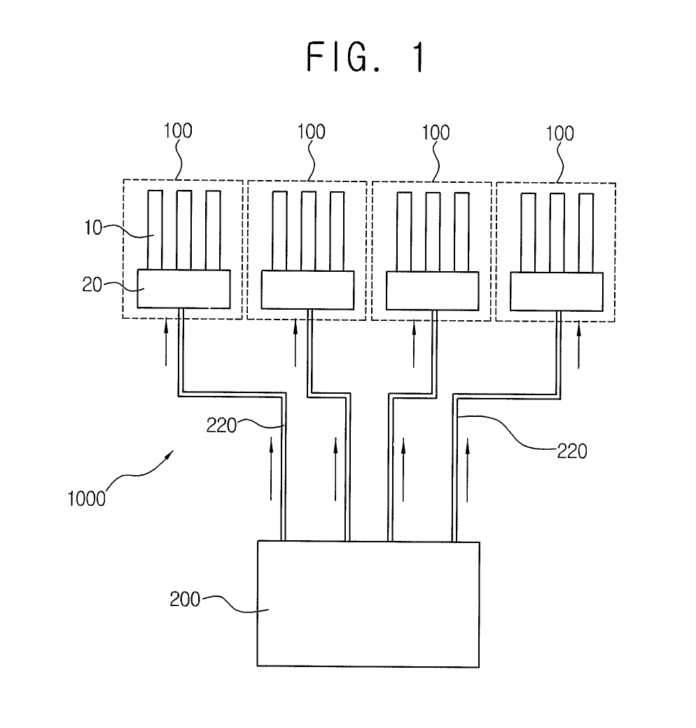

FIG. 1 is a schematic view showing the structure of a related fuel cell stack 1000. In FIG. 1, a plurality of unit cells 10 that generate electricity are connected to a manifold 20 to form a bundle unit (or bundle portion) 100. Further, a plurality of bundle portions 100 is connected to a separate fuel supply unit 200 to form a stack 1000.

In this instance, the respective bundle portions 100 are simultaneously and separately connected to the fuel supply unit 200 through fuel supply tubes 220 to receive fuel supplied from the fuel supply unit 200. As the fuel supply tubes 220 are individually provided to the respective bundle portions 100, the respective bundle portions 100 receive the fuel supplied through independent fuel supply paths. In addition, a separate fuel discharge unit may be provided together with the fuel supply unit 200 in the fuel cell stack 1000. The fuel discharge unit may have various structures. Therefore, the fuel discharge unit is not separately shown in FIG. 1.

In the fuel cell stack 1000 of FIG. 1, the fuel is distributed to the respective bundle portions 100 through the fuel supply tubes 220. Then, the fuel supplied to each of the bundle portions 100 is again distributed in the manifold 20 of each of the bundle portions 100, and the distributed fuel is supplied to each of the unit cells 10.

However, in a stack 1000 having such a fuel supply structure, the respective bundle portions 100 are simply connected to the fuel supply unit 200 through the fuel supply tubes 220. Therefore, the fuel supply cannot be individually controlled (e.g., stopped) for a particular bundle portion 100 unless the driving of the entire stack 1000 is controlled (e.g., stopped). That is, although the driving of a specific one of the bundle portions 100 may be impossible due to a defect of the one specific bundle portion 100, it is not possible to block the fuel supply to the one specific bundle portion 100 without also blocking the entire fuel supply to the other bundle portions.

As a result, in order to continue driving a fuel cell stack 1000 that includes a defective bundle portion 100, the fuel is continuously supplied to the defective bundle portion 100 as well as to any defective unit cells 10 included in the defective bundle portion 100. For example, a defective unit cell 10 may have cracks, thus causing fuel to leak. In a case where the fuel is continuously supplied to such a defective unit cell 10, the defective unit cell 10 may explode because of the external current collecting process between the unit cells 10, and the performance of the other unit cells 10 may be degraded. As the fuel is unnecessarily supplied to the defective unit cell 10 (for which driving is impossible), the fuel is wasted.

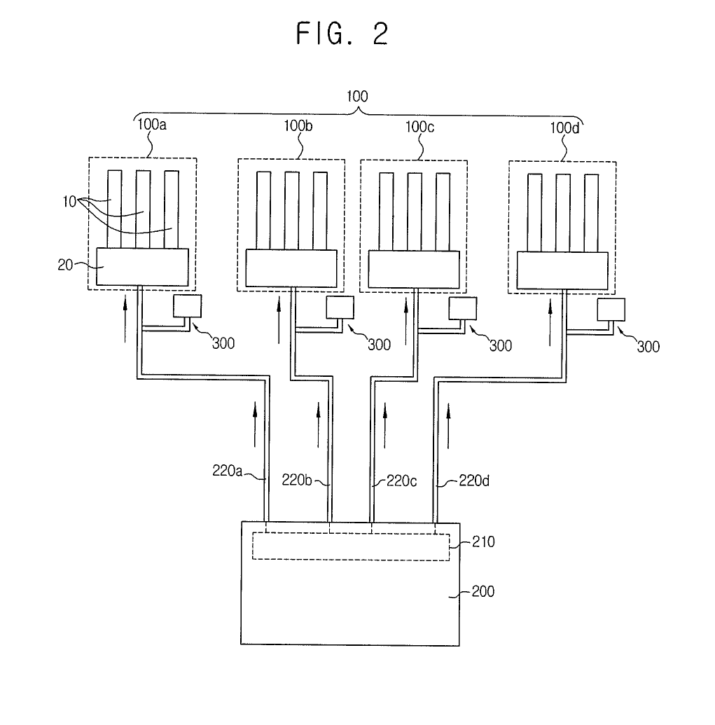

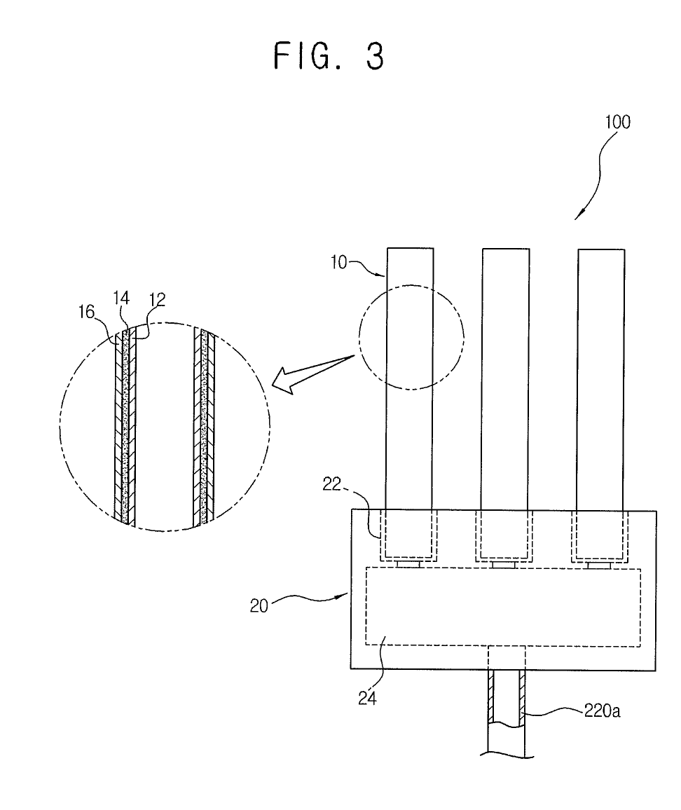

FIG. 2 is a schematic view showing the fuel supply structure of a solid oxide fuel cell stack according to an embodiment of the present invention. FIG. 3 is an enlarged schematic view showing the structure of each bundle portion 100 in the stack of FIG. 2. As shown in FIG. 2, the fuel cell stack generally includes bundle portions 100, a fuel supply unit 200, and fuel-blocking units 300.

In the solid oxide fuel cell stack of FIG. 2, the bundle portion 100 is a portion in which electricity is generated and collected. As shown in FIGS. 2 and 3, the bundle portion 100 includes unit cells 10 and a manifold 20.

The unit cell 10 is a portion that substantially generates electricity in the bundle portion. As shown in the inset of FIG. 3, the unit cell 10 has a multiple layer structure in which a first electrode 12 corresponding to an anode, an electrolytic layer 14, and a second electrode 16 corresponding to a cathode are sequentially stacked. Although not shown in FIGS. 2 and 3, current collecting bodies for internal and external current collections may be formed on the inner and outer circumferential surfaces of the unit cell 10.

Since the current collection efficiency of only one unit cell 10 is insufficient, a plurality of unit cells 10 are connected to one manifold 20 to form one bundle portion 100. In this instance, the manifold 20 functions to connect the unit cells 10 and to distribute fuel supplied from the fuel supply unit 200, which will be described later, to the unit cells 10.

As shown in FIG. 3, the manifold 20 has coupling ports 22 through which end portions of the respective unit cells 10 are coupled to the manifold 20 at one side of the manifold 20. The manifold 20 also has a terminal portion (not shown) for collecting current between the coupled unit cells 10. The coupling ports 22 are connected to a fuel distribution chamber 24 formed at one side thereof. As such, a plurality of unit cells 10 are connected to one manifold 20 to form one bundle portion 100, and a plurality of such bundle portions 100 are connected to the fuel supply unit 200 to form one stack.

For convenience of illustration, the bundle portions 100 are divided into first, second, third, and fourth bundle portions 100a, 100b, 100c, and 100d as shown in FIG. 2. However, the number of bundle portions 100 may be increased or decreased in consideration of the entire capacity of the fuel cell stack.

The fuel supply unit 200 functions to distribute hydrogen gas fuel generated through a fuel reformer (not shown) and an oxidation reactor (not shown) to the bundle portions 100a, 100b, 100c, and 100d. The fuel supply unit 200 includes a fuel distribution portion 210.

The fuel distribution portion 210 functions to distribute hydrogen fuel discharged from a selective oxidation reactor to each fuel path. Fuel supply tubes 220a, 220b, 220c, and 220d connected to the fuel distribution portion 210 serve as fuel supply paths between the fuel distribution portion 210 and the respective bundle portions 100a, 100b, 100c, and 100d. The fuel supply tubes are formed in a simple tube shape. End portions of the fuel supply tubes 220a, 220b, 220c, and 220d are connected to respective fuel discharge ports of the fuel distribution portion 210, and other end portions of the fuel supply tubes 220a, 220b, 220c, and 220d are connected to the respective fuel distribution chambers 24 of the manifolds 20 in the bundle portions 100a, 100b, 100c, and 100d.

For reference, the number of fuel supply tubes 220 shown in FIG. 2 is four, namely, first, second, third, and fourth fuel supply tubes 220a, 220b, 220c, and 220d, to correspond to the number of the bundle portions 100. However, the number of fuel supply tubes 220 may be modified depending on the number of bundle portions 100.

As the fuel supply tubes 220a, 220b, 220c, and 220d are separately connected to the respective bundle portions 100a, 100b, 100c, and 100d, the hydrogen fuel discharged from the fuel distribution portion 210 is supplied to the bundle portions 100a, 100b, 100c, and 100d along individual paths through the fuel supply tubes 220a, 220b, 220c, and 220d, respectively.

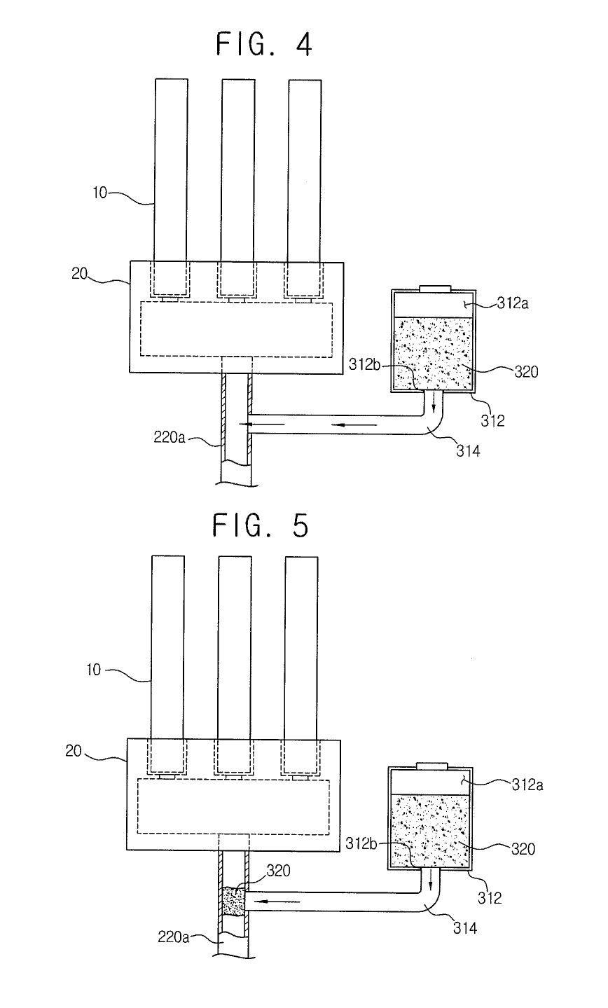

In addition to the above-described structure of the fuel cell stack, a fuel-blocking unit 300 is further provided to the fuel cell stack as shown in FIG. 2. The fuel-blocking unit 300 is used to selectively block only the fuel supply to a specific bundle portion in a case where a defect of the specific bundle portion occurs. Embodiments of the fuel-blocking unit 300 of FIG. 2 are shown in detail in FIGS. 4 to 7.

In the embodiments depicted in FIGS. 4-6, the fuel-blocking unit includes an accommodating portion 312 provided with a fuel-blocking member 320 and a connection tube 314 for transferring the fuel-blocking member 320 in the accommodating portion 312 to each of the fuel supply tubes 220a, 220b, 220c, and 220d. That is, the accommodating portion 312 functions to accommodate the fuel-blocking member 320, and the connection tube 314 serves as a moving path of the fuel-blocking member 320. The fuel-blocking member 320 is an element that substantially blocks the fuel supply to each of the bundle portions 100.

The fuel-blocking unit 300 may be implemented in different forms for different exemplary embodiments. Therefore, three embodiments of the fuel-blocking unit 300 of FIG. 2 will be described below with reference to FIGS. 4-7.

### First Embodiment

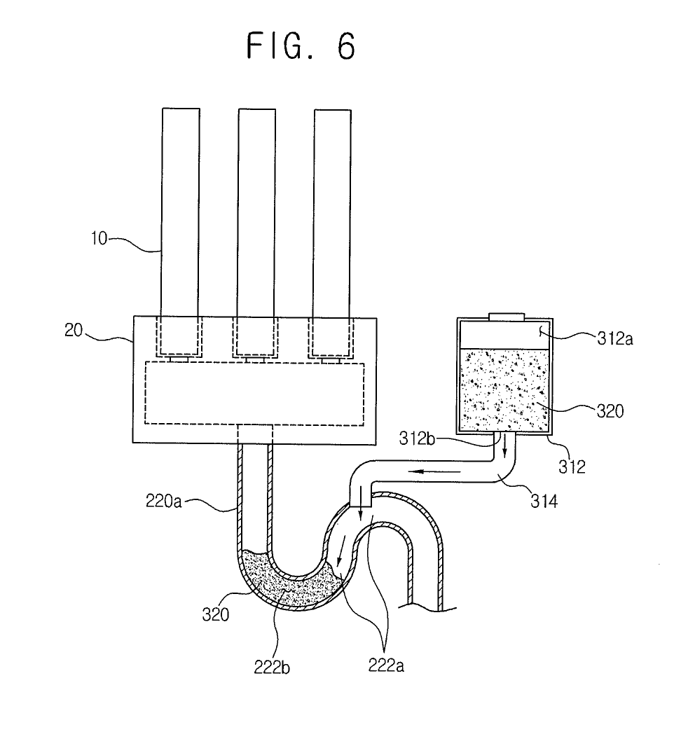

FIG. 4 is a schematic view showing a fuel-blocking unit according a first embodiment of the present invention. FIG. 5 is a schematic view showing a fuel supply tube 220a that is blocked by a fuel-blocking member 320 in the fuel-blocking unit of FIG. 4. The fuel-blocking unit in this embodiment includes an accommodating portion 312 (having a fuel-blocking member 320 accommodated therein) and a connection tube 314.

The accommodating portion 312 is a portion in which the fuel-blocking member 320, which will be described later, is initially stored. The accommodating portion 312 has a general storage tank structure in which an accommodating space 312a is formed in the accommodating portion 312, and a discharge port 312b for the fuel-blocking member 320 is formed at one side of the accommodating portion 312. The accommodating portion 312 is positioned at one side of each of the fuel supply tubes 220a, 220b, 220c, and 220d.

The connection tube 314 connects the accommodating portion 312 to each of the fuel supply tubes 220 of the fuel supply unit 200 to serve as a moving path of the fuel-blocking member 320. The connection tube 314 may, for example, have the form of a tube structure. One end of the connection tube 314 is connected to the discharge port 312b of the accommodating portion 312, and the other end of the connection tube 314 is connected to the fuel supply tube 220. In this embodiment, a valve (not shown) or the like may be provided near the connection point with the accommodating portion 312 or near the connection point with each of the fuel supply tubes 220a, 200b, 220c, and 220d to control the supply of the fuel-blocking member 320.

The fuel-blocking member 320 that constitutes the fuel-blocking unit of FIGS. 4-5 together with the accommodating portion 312 and the connection tube 314 is an element that substantially blocks the fuel supply to each of the bundle portions 100 as described above. In this embodiment, the fuel-blocking member 320 may be made of a ceramic material in a slurry state. For instance, a ceramic material that is plastically deformable at the driving temperature of a solid oxide fuel cell may be used as the fuel-blocking member 320. That is, in a case where the ceramic material is used for the fuel-blocking member 320 to a solid oxide fuel cell system, the ceramic material may plastically deform at about 800° C., which corresponds to a driving temperature of the system, to have a porosity of about 10% or lower, preferably a porosity of about 5% or lower. In a case where the porosity is greater than 10%, the substantial effect of blocking the fuel may be reduced. Although the driving temperature of the solid oxide fuel cell is about 800° C., a material having plastic deformation at a temperature of about 500° C. to 1000° C. may be used.

The fuel-blocking unit of FIGS. 4-5 is provided to each of the fuel supply tubes 220a, 220b, 220c, and 220d to be individually operated. Although not shown in FIGS. 4-5, a separate pump or the like may be provided to the accommodating portion 312, if necessary, so that the fuel-blocking member 320 is discharged from the accommodating portion 312 by a pumping pressure.

Hereinafter, the operation and effect of the embodiment shown in FIGS. 4-5 will be described. First, as shown in FIG. 2, the hydrogen fuel distributed in the fuel distribution portion 210 of the fuel supply unit 200 is individually supplied to the bundle portions 100a, 100b, 100c, and 100d through the respective fuel supply tubes 220a, 220b, 220c, and 220d, and the supplied fuel is finally supplied to the unit cells 10 through the manifolds 20 of the respective bundle portions 100a, 100b, 100c, and 100d.

Then, internal current collection is performed by the reaction between hydrogen and oxygen in each of the unit cells 10 to which the fuel is supplied, and electricity generated from each of the unit cells 10 is collected at the exterior through the manifold 20. In such a manner, the electricity is separately generated in each of the bundle portions 100a, 100b, 100c, and 100d. Since the bundle portions 100a, 100b, 100c, and 100d are electrically connected to one another through an electric wire or the like, the electricity generated from each of the bundle portions 100a, 100b, 100c, and 100d is finally collected by the connection among the bundle portions 100a, 100b, 100c, and 100d.

In the driving process of the fuel cell, the normal driving of the fuel cell may be impossible because cracks (or other defects) occur in one of the unit cells 10 of, for example, the first bundle portion 100a. In this case, if the fuel-blocking unit of FIGS. 4-5 is operated, the fuel-blocking member 320 is discharged from the accommodating portion 312 by the operation of a discharge unit (not shown) such as a pump, moved along the connection tube 314 and then accumulated in the first fuel supply tube 220a, as shown in FIG. 5.

The fuel-blocking member 320 accumulated in the first fuel supply tube 220a is plastically deformed by the driving temperature of the fuel cell, and a partial section in the first fuel supply tube 220a is completely blocked. Therefore, the fuel supply to the first bundle portion 100a is blocked.

As the fuel supply to a bundle portion 100 having a defect is selectively blocked, it is possible to prevent the fuel from leaking in the defective bundle portion 100, thereby preventing the risk of explosion due to the fuel leakage in the defective bundle portion 100. In addition, the fuel unnecessarily supplied to a defective (e.g., leaking) unit cell 10 (for which driving is impossible) is blocked, thereby preventing waste of the fuel.

For reference, since the bundle portions 100a, 100b, 100c, and 100d are electrically connected to one another as described above, the first bundle portion 100a of which fuel supply is blocked loses the function of generating electricity but continues to serve as an electrical connection (for example, via an electric wire) among the bundle portions 100a, 100b, 100c, and 100d.

### Second Embodiment

FIG. 6 is a schematic view showing a fuel-blocking unit according to a second embodiment of the present invention. In this embodiment, the configuration is similar to that of the embodiment illustrated in FIGS. 4-5. However, this embodiment is different in that S-shaped curved flow paths 222a and 222b are formed near the connection point of each of the fuel supply tubes 220a, 220b, 220c, and 220d with the manifold 20, and the connection tube 314 of the fuel-blocking unit of FIG. 6 is connected to the curved flow paths 222a and 222b.

As shown in FIG. 6, in a normal operating configuration, S-shaped curved flow path 222b is lower than the curved flow path 222a. As such, the fuel-blocking member 320 discharged from the fuel-blocking unit of FIG. 6 is naturally accumulated at a lower position (that is, curved flow path 222b) than that of the curved flow path 222a.

Therefore, if the first bundle portion 100a has a defect, the fuel-blocking member 320 is discharged from the accommodating portion 312 and then injected into the first fuel supply tube 220a as described in the embodiment shown in FIGS. 4-5. The injected fuel-blocking member 320 is accumulated in a recessed section (e.g., in the curved flow path 222b) by its own weight in the process of passing through the curved flow paths 222a and 222b. In this state, the fuel-blocking member 320 is plastically deformed to block the fuel supply path. In this embodiment, the recessed section refers to a portion designated by reference numeral 222b in the curved flow paths.

As the fuel-blocking member 320 is accumulated in the curved flow paths 222a and 222b of each of the fuel supply tubes 220a, 220b, 220c, and 220d, it is not easily swept by the flow of the fuel but instead accumulates in the fuel supply tubes 220a, 220b, 220c, and 220d as compared with the embodiment of FIGS. 4-5, in which the fuel-blocking member 320 is accumulated in the straight-line flow path. Accordingly, the blocking efficiency in the fuel supply path can be increased in this embodiment.

### Third Embodiment

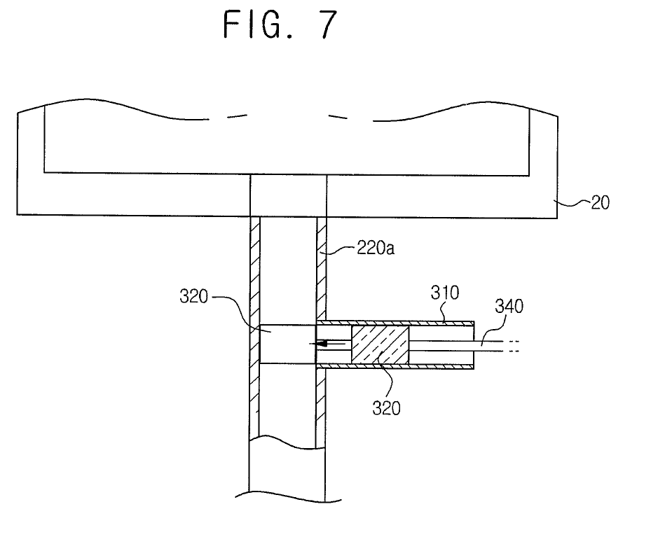

FIG. 7 is a schematic view showing a fuel-blocking unit according to a third embodiment of the present invention. The basic configuration of this embodiment is similar to the earlier embodiments (of FIGS. 4-6) discussed above. However, this embodiment is slightly different from those embodiments in that the structure of the fuel-blocking unit of FIG. 7 and the blocking method of the fuel supply path are mechanically implemented.

Specifically, in this embodiment, the fuel-blocking member 320 is formed as a block-shaped barrier. A separate driving portion 340 allows the block-shaped fuel-blocking member 320 to be pushed into each of the fuel supply tubes 220a, 220b, 220c, and 220d through a straight-line guide tube 310. The guide tube 310 is connected to each of the fuel supply tubes 220a, 220b, 220c, and 220d while serving as a transfer path of the block-shaped fuel-blocking member 320 in the interior thereof.

The fuel-blocking member 320 is formed in the shape of a block having the same width as the inside diameter of each of the fuel supply tubes 220a, 220b, 220c, and 220d. That is, the fuel-blocking member 320 is necessarily circumscribed in the fuel supply tube to have a sealing effect.

The fuel-blocking member 320 may be separately connected to the driving portion 340 having the type of a cylinder rod or jig to be moved by the driving force of the driving portion 340. Alternatively, the driving portion 340 may have the type of an air compression device or the like so that the fuel-blocking member 320 is pushed and moved by the air pressure obtained by supplying compressed air into the guide tube 310.

A ceramic material may be used as the fuel-blocking member 320. In addition, the fuel-blocking member 320 can be any material and structure that have a sufficient sealing property in each of the fuel supply tubes 220a, 220b, 220c, 220d.

In this embodiment, the flow of fuel is blocked by simply moving the fuel-blocking member 320 toward each of the fuel supply tubes 220a, 220b, 220c, 220d and blocking each of the fuel supply tubes 220a, 220b, 220c, 220d. As the fuel-blocking structure is entirely implemented using a simple mechanical method, this embodiment is advantageous in that the fuel-blocking process can be rapidly and simply performed as compared with the earlier embodiments of FIGS. 4-6 in which the flow path is blocked by passing through a plastic deforming process after slurry is accumulated.

As described above, the fuel supply to a bundle portion 100 with a defect is selectively blocked through the fuel-blocking unit, so that it is possible to continue the driving operation of the stack while reducing or preventing the risk of explosion due to fuel leakage or the like and while reducing or preventing the degradation of the performance of the entire stack.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A fuel cell stack comprising:
a bundle portion comprising a plurality of unit cells each having a stacked structure of a first electrode, an electrolytic layer, and a second electrode, and a manifold connected to the plurality of unit cells;
a fuel supply portion connected to the manifold of the bundle portion through a fuel supply tube provided at one side thereof; and
a fuel-blocking unit connected to the fuel supply tube and configured to block the fuel supply tube.

2. The fuel cell stack according to claim 1, wherein:
the bundle portion comprises a plurality of bundle portions, and
the bundle portions are electrically connected to one another.

3. The fuel cell stack according to claim 2, wherein:
the fuel supply tube comprises a plurality of fuel supply tubes,
the fuel-blocking unit comprises a plurality of fuel-blocking units,
the fuel supply tubes are connected to respective ones of the bundle portions, and
the fuel-blocking units are connected to respective ones of the fuel supply tubes.

4. The fuel cell stack according to claim 1, wherein the fuel-blocking unit comprises:
an accommodating portion that accommodates a fuel-blocking member; and
a connection tube to communicate with the interior of the fuel supply tube.

5. The fuel cell stack according to claim 4, wherein the fuel-blocking member comprises slurry.

6. The fuel cell stack according to claim 4, wherein the fuel-blocking member comprises a ceramic material having a plastic deforming temperature of about 800° C. or higher.

7. The fuel cell stack according to claim 4, wherein the fuel-blocking member is plastically deformed near a driving temperature of the fuel cell stack.

8. The fuel cell stack according to claim 4, wherein the fuel-blocking member has a porosity of less than 10% in its plastic deformation.

9. The fuel cell stack according to claim 4, wherein the fuel supply tube is formed in a shape of a curved flow path so that the fuel-blocking member is configured to be injected into the curved flow path.

10. The fuel cell stack according to claim 9, wherein the connection tube is connected to a curved portion of the fuel supply tube.

11. The fuel cell stack according to claim 1, wherein
the fuel-blocking unit comprises a straight-line guide tube having one end connected to the fuel supply tube, and
a fuel-blocking member is configured to move through the guide tube.

12. The fuel cell stack according to claim 11, wherein the fuel-blocking member is formed in a shape of a block that is installed and configured to move in the guide tube.

13. The fuel cell stack according to claim 11, wherein the fuel-blocking unit further comprises a driving portion connected to the fuel-blocking member to move the fuel-blocking member.

14. The fuel cell stack according to claim 11, wherein the fuel-blocking member is configured to be circumscribed in the fuel supply tube.

15. The fuel cell stack according to claim 1, wherein the fuel cell stack is a solid oxide fuel cell stack.
